(19) United States
(12) Patent Application Publication
(10) Pub. No.: US 2009/0319990 A1
(43) Pub. Date: Dec. 24, 2009

(54) OBJECT ORIENTED GENETIC PROGRAMMING

(75) Inventors: Jinfei Fan, Ottawa, CA (US); Frank Oppacher, Almonte (CA)

Correspondence Address: MICHAEL A DESANCTIS;HAMILTON DESANCTIS & CHA LLP, FINANCIAL PLAZA AT UNION SQUARE, 225 UNION BOULEVARD, SUITE 305, LAKEWOOD, CO, 80228, US

(73) Assignee: 7163177 CANADA LIMITED, Ottawa (CA)

(21) Appl. No.: 12/475,819

(22) Filed: Jun. 1, 2009

Related U.S. Application Data
(60) Provisional application No. 61/074,671, filed on Jun. 22, 2008.
(60) Provisional application No. 61/167,487, filed on Apr. 7, 2009.

(51) Int. Cl. G06F 9/44

(52) U.S. Cl. 717/116

(57) ABSTRACT

Methods and systems for performing object oriented genetic programming are provided. According to one embodiment, a population of computer program representations are varied to create a new population by generating additional computer program representations based on those of the computer program representations selected in accordance with a selection strategy. Each computer program representation is modeled as a linear array of genes, each gene having domain-specific values and an action or operation to be performed on the basis of the domain-specific values. It is determined whether any computer program representations of the new population satisfy any predetermined performance criteria. If so, then such computer program representations are identified as potential solutions to the problem at issue; otherwise, subsequent generations are generated until one or more predetermined performance criteria are satisfied.

### CROSS-REFERENCE TO RELATED APPLICATIONS

This application claims the benefit of priority to U.S. Provisional Patent Application No. 61/074,671, filed on Jun. 22, 2008 and to U.S. Provisional Patent Application No. 61/167,487, filed on Apr. 7, 2009, both of which are hereby incorporated by reference in their entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2008-2009, Jinfei Fan.

### BACKGROUND

1. Field

Embodiments of the present invention generally relate to evolutionary computation and the use of genetic algorithms to generate computer programs. In particular, embodiments of the present invention relate to the application of object oriented concepts in genetic programming and the use of (i) a unique linear chromosome representation and (ii) objects as building materials to achieve faster convergence with smaller populations thereby reducing overall computational effort and making object oriented genetic programming (OOGP) methodologies practical for a wider range of problem domains.

2. Description of the Related Art

Genetic programming (GP) is about using genetic algorithms to generate computer programs. GP has been successfully applied in a few of engineering's domains, but there are limitations as a result of the underlying implementation of traditional GP algorithms. For example, due to the population size requirements and the number of generations required to solve problems, current GP algorithms cannot handle large scale problems. Thus, an improved GP approach is needed to increase the applicability and usefulness of GP.

### SUMMARY

Methods and systems are described for performing object oriented genetic programming. According to one embodiment, a method is provided for identifying a computer program solution to a problem at issue in a particular domain. One or more software modules, implemented in one or more processors and one or more computer-readable media of one or more computer systems, in which the one or more computer-readable media have instructions tangibly embodied therein that are executable by the one or more processors, vary a population of computer program representations tangibly embodied within a computer-readable medium to create a new population by generating additional computer program representations based on one or more of the computer program representations selected in accordance with a selection strategy. Each of the computer program representations is modeled as a linear array of genes, each of which has associated therewith one or more domain-specific values and an action or operation to be performed on the basis of the one or more domain-specific values. The software modules determine whether any computer program representations of the new population satisfy one or more predetermined performance criteria. If the one or more predetermined performance criteria are satisfied by one or more of the computer program representations of the new population, then the one or more software modules identify the one or more of the computer program representations as potential solutions to the problem at issue. If none of the computer program representations of the new population satisfy the predetermined performance criteria, then the one or more software modules continue to generate one or more subsequent generations until the one or more predetermined performance criteria are satisfied.

In the aforementioned embodiment, the selection strategy may involve selecting for inclusion within the new population a predetermined or configurable percentage of the population that performs better than a remaining portion of the population as measured by a fitness function.

In various of the aforementioned embodiments, the selection strategy may involve randomly choosing a first parent from a first portion of the population and randomly choosing a second parent from a second portion of the population.

In the context of various of the aforementioned embodiments, the first portion of the population exhibits performance as measured by a fitness function that is deemed more desirable than performance exhibited by the second portion of the population.

In some instances of the aforementioned embodiments, additional computer program representations are generated by generating an offspring to be included within the new population by performing a crossover operation based on the first parent and the second parent.

In various of the aforementioned embodiments, the method may also include mutating the offspring by randomly replacing at least a portion of the linear array of genes.

In the context of various of the aforementioned embodiments, each gene may include a portion of source code of the corresponding computer program representation.

In various of the aforementioned embodiments, each gene may include data for input to Code Document Object Model statement classes.

In some instances of the aforementioned embodiments, the one or more predetermined performance criteria may include a measure of proximity between a result generated by a computer program representations of the new population and a predetermined result.

In some instances of the aforementioned embodiments, the action or operation may include a no-op operation.

Other embodiments of the present invention provide a computer-readable storage medium tangibly embodying a set of instructions, which when executed by one or more processors of one or more computer systems, cause the one or more processors to perform a method for identifying a computer program solution to a problem at issue in a particular domain. A population of computer program representations tangibly embodied within a computer-readable medium are varied to create a new population by generating additional computer program representations based on one or more of the computer program representations selected in accordance with a selection strategy. Each of the computer program representations are modeled as a linear array of genes. Each gene has associated therewith one or more domain-specific values and an action or operation to be performed on the basis of the one or more domain-specific values. A determination is made whether any computer program representations of the new population satisfy one or more predetermined performance criteria. One or more of the computer program representations are identified as potential solutions to the problem at issue if the one or more predetermined performance criteria are satisfied by one or more of the computer program representations of the new population. Otherwise, if none of the computer program representations of the new population satisfy the predetermined performance criteria, one or more subsequent generations are generated until the one or more predetermined performance criteria are satisfied.

In the aforementioned embodiment, the selection strategy may involve selecting for inclusion within the new population a predetermined or configurable percentage of the population that performs better than a remaining portion of the population as measured by a fitness function.

In various of the aforementioned embodiments, the selection strategy may involve randomly choosing a first parent from a first portion of the population and randomly choosing a second parent from a second portion of the population.

In the context of various of the aforementioned embodiments, the first portion of the population exhibits performance as measured by a fitness function that is deemed more desirable than performance exhibited by the second portion of the population.

In some instances of the aforementioned embodiments, the generation of additional computer program representations involves generating an offspring to be included within the new population by performing a crossover operation based on the first parent and the second parent.

In various of the aforementioned embodiments, the set of instructions further cause the one or more processors to mutate the offspring by randomly replacing at least a portion of the linear array of genes.

In the context of various of the aforementioned embodiments, each gene may include a portion of source code of the corresponding computer program representation.

In some instances of the aforementioned embodiments, each gene may include data for input to Code Document Object Model statement classes.

In the context of various of the aforementioned embodiments, the one or more predetermined performance criteria may involve a measure of proximity between a result generated by a computer program representations of the new population and a predetermined result.

In the context of various of the aforementioned embodiments, the action or operation comprises a no-op operation.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a representation of a function in the context of traditional tree-based genetic programming methodologies.

FIG. 2 illustrates a crossover operation in the context of traditional tree-based genetic programming methodologies.

FIG. 3 illustrates a mutation operation in the context of traditional tree-based genetic programming methodologies.

FIG. 4 conceptually illustrates the relationship between building materials and a chromosome in the context of traditional tree-based genetic programming methodologies.

FIG. 5 conceptually illustrates the relationship between building materials and a chromosome in accordance with various embodiments of the present invention.

FIG. 6 conceptually illustrates a potential object-oriented implementation of traditional tree-based genetic programming methodologies.

FIG. 7 is an example of a computer system with which embodiments of the present invention may be utilized.

FIG. 8 is a high-level flow diagram illustrating object-oriented genetic programming (OOGP) search processing in accordance with an embodiment of the present invention.

FIG. 9 is a Unified Modeling Language (UML) class diagram illustrating various classes in accordance with various embodiments of the present invention.

FIG. 10 is a flow diagram illustrating initialize processing for the OOGPSearch class of FIG. 9 in accordance with an embodiment of the present invention.

FIG. 11 is a flow diagram illustrating run processing for the OOGPSearch class of FIG. 9 in accordance with an embodiment of the present invention.

FIG. 12A is a flow diagram illustrating initialize processing for the Individual class of FIG. 9 in accordance with an embodiment of the present invention.

FIG. 12B is a flow diagram illustrating run processing for the Individual class of FIG. 9 in accordance with an embodiment of the present invention.

FIG. 13 is a flow diagram illustrating crossover processing for the Individual class of FIG. 9 in accordance with an embodiment of the present invention.

FIG. 14 is a flow diagram illustrating mutation processing for the Individual class of FIG. 9 in accordance with an embodiment of the present invention.

FIG. 15A is a flow diagram illustrating initialize processing for the Gene class of FIG. 9 in accordance with an embodiment of the present invention.

FIG. 15B is a flow diagram illustrating run processing for the Gene class of FIG. 9 in accordance with an embodiment of the present invention.

FIG. 16 is a block diagram conceptually illustrating a resource pool in accordance with an embodiment of the present invention.

FIG. 17 illustrates a crossover operation in the context of various embodiments of the present invention.

FIG. 18 illustrates a mutation operation in the context of various embodiments of the present invention.

### DETAILED DESCRIPTION

Methods and systems are described for performing object oriented genetic programming (OOGP). According to one embodiment, the performance of GP algorithms is drastically improved by applying object oriented concepts to the very core of the genetic algorithms. In various embodiments of the present invention, the building materials are objects (e.g., type A objects and type B objects). Type A objects have data members and methods and serve as concrete placeholders. Type B objects are used as an abstraction of operation/action interface between type A objects. In such an embodiment, a chromosome may be represented as a linear sequence of genes, each of which includes two type A objects and one type B object.

According to one embodiment, no-ops (do nothing objects in Type B) are used to simulate redundant genes which are observed in nature. As a result of the introduction of a no-op operation, OOGP algorithms may automatically reduce the length of a chromosome (e.g., when they find there are too many no-ops in the chromosome).

No-ops also serve another purpose. In traditional tree-based GP approaches, to solve a given problem, many useless branches may be generated to fill a large search space (which must be set to accommodate the worst case tree depth and/or the worst case number of nodes). With the introduction of no-op, the algorithm has the ability to fill no-ops into the chromosome if the solution does not require all genes to be fully used.

In various OOGP implementations, chromosomes are represented as a linear sequence of genes having a fixed length. Thus, offspring have the same chromosome length as that of their parents and there is no need for a truncation operation to limit the number of nodes. In contrast, in traditional tree-based GP implementations since the portions of the chromosome inherited by offspring may have differing numbers of nodes, the generated offspring might have more nodes than their parents truncation is always necessary to keep the tree size within the processing and/or memory limitations of the host computer. Additionally, the linear nature of the OOGP chromosome representation tremendously reduces the computational effort compared with traditional tree-based GP approaches as the search space only increases when the number of nodes increases. In contrast, when the tree depth of a traditional tree-based GP approach is increased from N to N+1 for a binary tree, the total number of nodes has to be increased by 2^{N+1}.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable medium having stored thereon instructions, which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

### Terminology

Brief definitions of terms used throughout this application are given below.

The term “chromosome” generally relates to an instance of a class or data structure representing a linear sequence of genes associated with an individual in a population.

The phrase “computer program representation” is intended to broadly encompass any and all current and future well-specified, compact, combinatorial, and hierarchical programmatic representations, including, but not limited to graph representations of software systems, such as the various visual sublanguages of the UML, Code Document Object Model (CodeDOM), source code in the form of a high or low-level programming language (e.g., C, C++, C# Java, etc.) and computer programs in executable form.

The terms “connected” or “coupled” and related terms are used in an operational sense and are not necessarily limited to a direct connection or coupling.

The term “gene” generally relates to the atomic unit of inheritance in the context of OOGP. In various embodiments of OOGP described herein, individuals inherit one or more genes from each of their parents and as described further below, genes are the level at which crossover and mutation operations take place. Depending upon the particular implementation and/or problem domain, a gene may represent a unit of a computer program representation (e.g., a CodeDOM instruction, a programming language statement, a UML statement or the like) or an object containing appropriate data to enable generation of a unit of a computer program representation.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The term “responsive” includes completely or partially responsive.

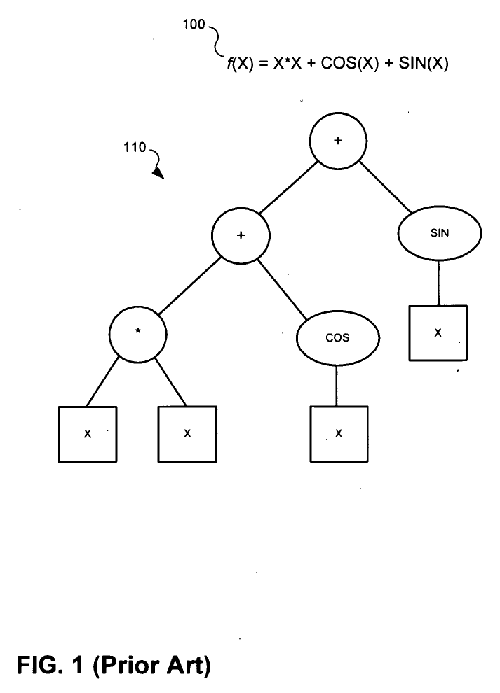

FIG. 1 illustrates a representation of a function 100 in the context of traditional tree-based GP methodologies. In traditional tree-based GP, a computer program is abstracted as a tree. An exemplary tree 110 for function 100, f(X)=X*X+COS(X)+SIN(X) has a depth of four and includes nine total nodes−five tree nodes (i.e., two tree nodes representing addition operations, one tree node representing a multiplication operation, one tree node representing a cosine operation and one tree node representing a sine operation) and four terminals.

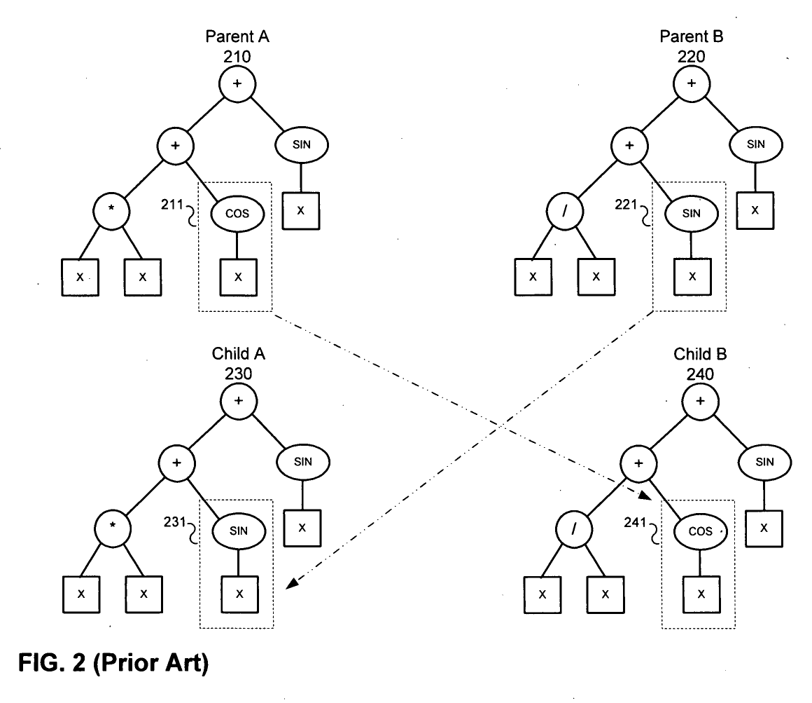

FIG. 2 illustrates a crossover operation in the context of traditional tree-based GP methodologies. First, a branch 211 and 221 is selected from each parent (i.e., parent A 210 and parent B 220). Then, the branches 221 and 221 are exchanged to produce the offspring (i.e., child A 230 and child B 240). As a result, in the current example, child A 230 is the same as parent A 210 with the exception that branch 211 has been replaced with branch 221 to create branch 231 of child A 230; and child B 240 is the same as parent B 220 with the exception that branch 221 has been replaced with branch 211 to create branch 241 in child B 240.

As mentioned earlier, due to the tree-based representation and the potentially differing number of nodes in different branches, a customized crossover operator must typically be implemented to ensure the tree depth of the offspring does not exceed a preconfigured maximum tree depth or that the total number of nodes of the offspring does not exceed a preconfigured maximum number of nodes.

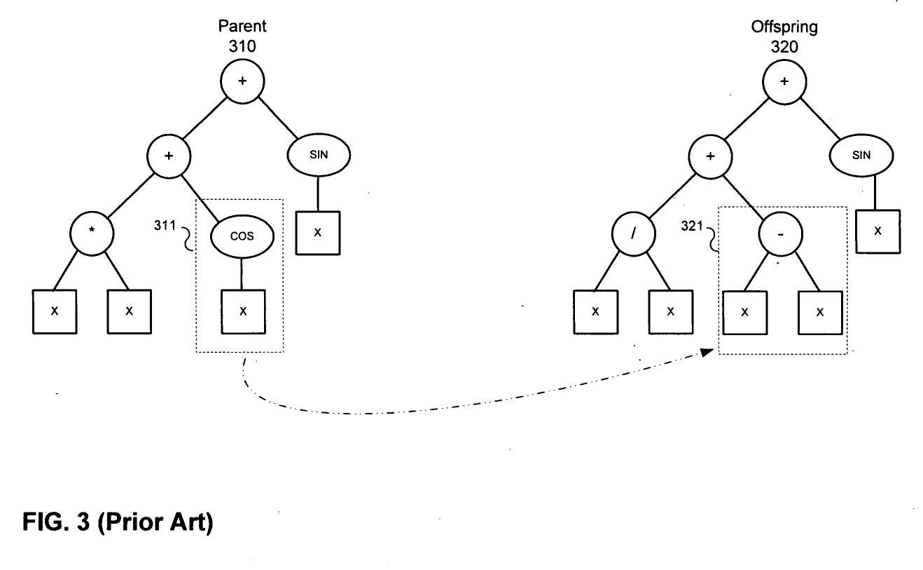

FIG. 3 illustrates a mutation operation in the context of traditional tree-based GP methodologies. First, a branch 311 is selected from a parent 310. Then, the branch 311 is randomly regenerated to create a corresponding branch 321 in a resulting mutant (i.e., offspring 320). As in the case of crossover, due to the tree-based representation and the potentially differing number of nodes and tree depth that may be produced in offspring, a customized mutation operator must typically be implemented to ensure the tree depth of the resulting mutants does not exceed a preconfigured maximum tree depth or that the total number of nodes of the resulting mutants does not exceed a preconfigured maximum number of nodes.

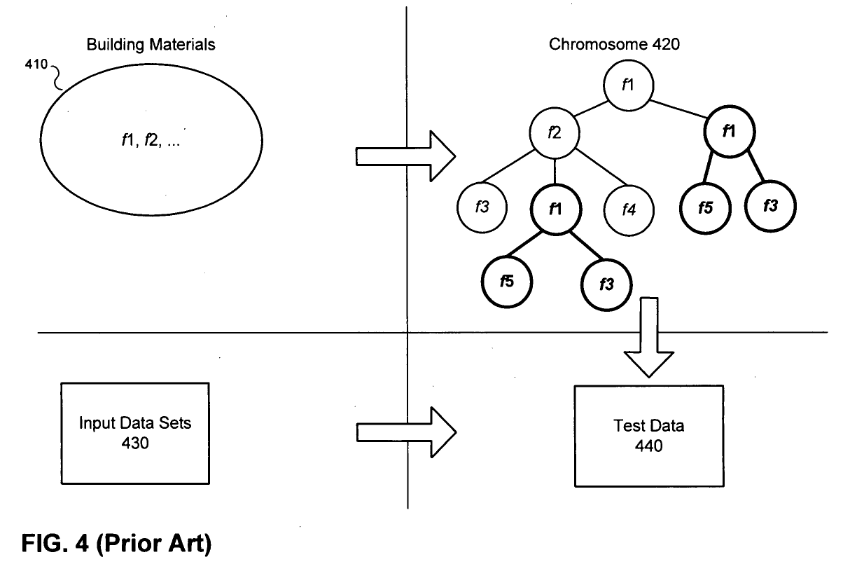

FIG. 4 conceptually illustrates the relationship between building materials and a chromosome in the context of traditional tree-based GP methodologies. In traditional tree-based GP methodologies, building materials comprise functions 410 and chromosomes, such as chromosome 420, are represented as a function trees. The chromosome 420 can be evaluated by applying the function tree to input data sets 430 to produce resulting test data 440.

Notably, even with automatically defined functions (ADFs), if two branches contain the same ADF, the two branches still have to be generated. For example, in chromosome 420, the two occurrences of function f1 with leaf nodes f5 and f3 still have to be repeated in the function tree. This is a disadvantage inherited from the tree-based representation. As will be discussed further below, in embodiments of OOGP, which include reusable objects, there is no need to reproduce the same branch. If such duplicates are common in the problem space at issue, it should be appreciated that OOGP will be much faster as a result of the smaller search space.

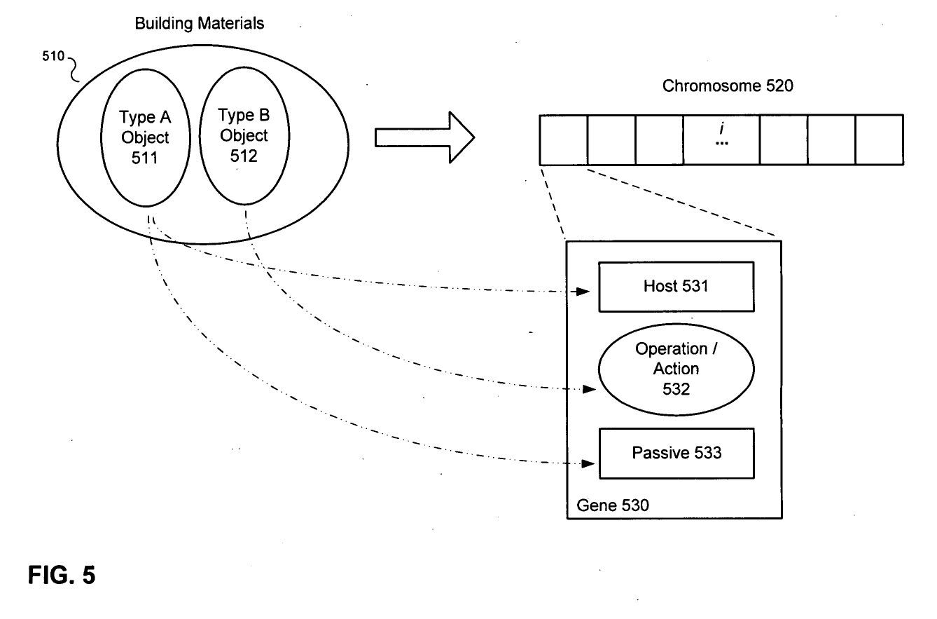

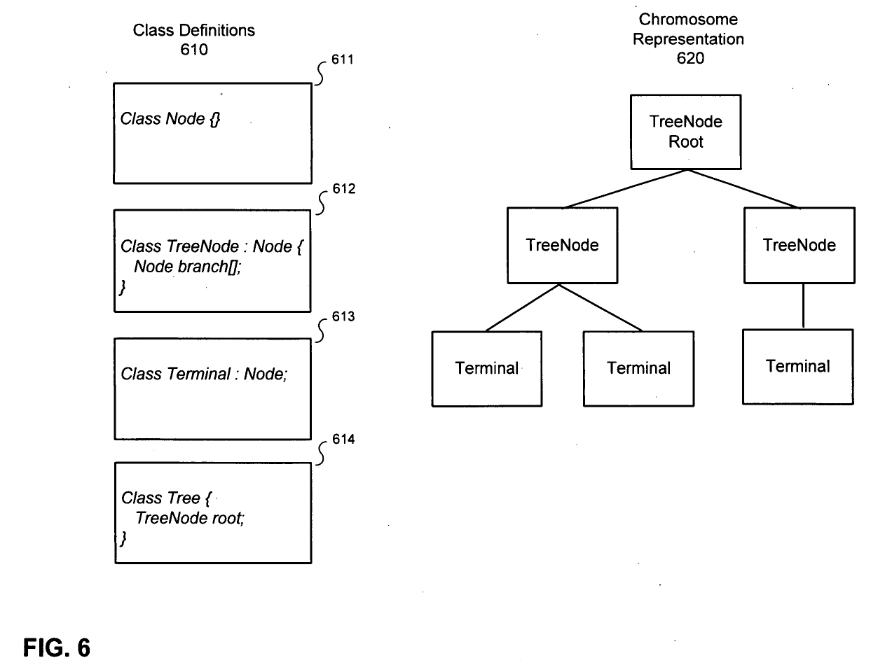

FIG. 5 conceptually illustrates the relationship between building materials 510 and a chromosome 520 in accordance with various embodiments of the present invention. Rather than taking a simple-minded and customary approach to applying object oriented concepts to the traditional tree-based GP algorithms (as illustrated with reference to FIG. 6), embodiments of the present invention seek to drastically improve the performance of GP algorithms by applying object oriented concepts to the very core of genetic algorithms.

In various embodiments of the present invention, the building materials 510 are objects (e.g., type A objects 51 and type B objects 512). In the current example, a chromosome 520 is represented as a linear sequence of genes 530. Each gene 530 includes one or more type A objects 511 (i.e., a host object 531 and a passive object 533) and one type B object 512, an operation/action object 532.

Type A objects 511 have data members and methods and serve as concrete placeholders. Type A objects 511 hold the interim states and the concrete meaning of actual simulated objects. The interim state is similar to the branch in the tree representation. It holds the temporary results during the computation. The interim state can be considered as a register in a computer processing unit (CPU), but its granularity is much larger than that of the register. This class has the data members as well as the implementations of the interfaces that are defined in Type B.

Type B objects 512 are used as an abstraction of operation/action interface 532 between type A objects 511. According to one embodiment, the operation/action interface 532 may be a no-op—meaning no action is performed on the one or more type A objects, e.g., host object 531 and passive object 533. As indicated earlier, no-ops may be used to simulate redundant genes which are observed in nature. Because of the existence of a no-op operation, OOGP algorithms may automatically reduce the length of chromosome 520 when it finds there are too many no-ops in the chromosome 520, for example.

No-ops provide an additional benefit. In traditional tree-based GP approaches many cumulative or otherwise useless branches may be generated to fill a large search space, which has been previously set to accommodate an estimated worst case tree depth and/or an estimated worst case number of nodes. No-ops provide a convenient mechanism to allow genes to be inactive if the solution does not require all genes to be fully utilized as the OOGP algorithm has the ability to fill no-ops into portions of the chromosome that are not needed.

Another advantage of the representation of chromosome 520 is that it is linear in nature. The length of chromosome can be increase to any extent desired (subject to resource limitations of the target computing platform) with a corresponding linear increase in resource utilization. In tree-based GP, to increase the tree depth from N to N+1 (for a binary tree), the total number of nodes must be increased by 2^{N+1}. Additionally, because offspring will have the same chromosome length as that of the parents, there is no need for a truncation operation as would be typically required in a traditional tree-based GP implementation to limit the number of nodes and/or depth of the tree.

FIG. 6 conceptually illustrates a potential object-oriented implementation of traditional tree-based genetic programming methodologies. The present example is not intended to illustrate or describe embodiments of the present invention but rather contrast various embodiments with routine application of object oriented concepts to traditional tree-based GP. While it should be apparent to those skilled in the art that OOGP algorithms employing various of the synergistic features described herein (e.g., linear chromosome representation, introduction of no-ops and building materials represented as objects) result in drastic and non-obvious improvements over traditional tree-based GP algorithms, an expected result of routine application of object oriented concepts to a traditional GP implementation will now be briefly described to illustrate the stark differences.

For purposes of this example, a set of class definitions 610 and a resulting chromosome representation 620 are illustrated. The class definitions 610 include an abstract class definition of a Node 611 as well as subclass definitions for root, intermediate, and terminal nodes (i.e., Tree 614, Tree Node 612 and Terminal 613). The chromosome representation 620 is that of a typical tree-based GP implementation but for the fact that it is constructed of instances of the aforementioned classes. Based on this example, it should be appreciated that routine application of object oriented concepts to traditional tree-based GP would result in something having no similarity to various embodiments of the present invention.

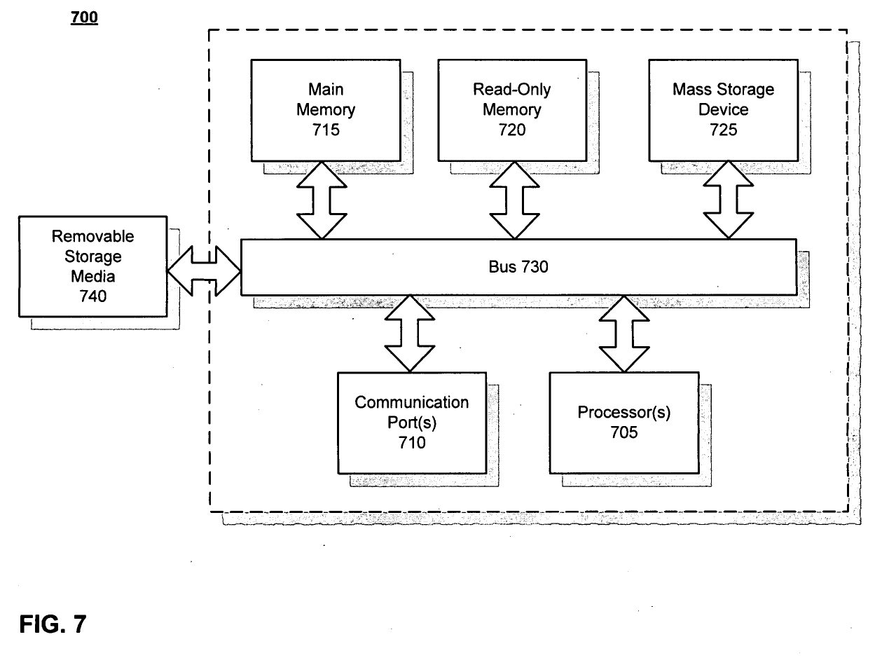

FIG. 7 is an example of a computer system 700 with which embodiments of the present invention may be utilized. Embodiments of the present invention include various steps, which will be described in more detail below. A variety of these steps may be performed by hardware components or may be tangibly embodied on a computer-readable medium in the form of machine-executable instructions, which may be used to cause one or more general-purpose or special-purpose computer processors or microprocessors programmed with instructions to perform these steps. Alternatively, the steps may be performed by a combination of hardware, software, and/or firmware. As such, FIG. 7 is an example of a computer system 700, such as a workstation, personal computer, laptop, client or server, upon which or with which embodiments of the present invention may be employed.

According to the present example, the computer system includes a bus 730, one or more processors 705, one or more communication ports 710, a main memory 715, a removable storage media 740, a read only memory 720 and a mass storage 725.

Processor(s) 705 can be any future or existing processor, including, but not limited to, an Intel® Itanium® or Itanium 2 processor(s), or AMD® Opteron® or Athlon MP® processor(s), or Motorola® lines of processors. Communication port(s) 710 can be any of an RS-232 port for use with a modem based dialup connection, a 10/100 Ethernet port, a Gigabit port using copper or fiber or other existing or future ports. Communication port(s) 710 may be chosen depending on a network, such a Local Area Network (LAN), Wide Area Network (WAN), or any network to which the computer system 700 connects.

Main memory 715 can be Random Access Memory (RAM), or any other dynamic storage device(s) commonly known in the art. Read only memory 720 can be any static storage device(s) such as Programmable Read Only Memory (PROM) chips for storing static information such as start-up or BIOS instructions for processor 705.

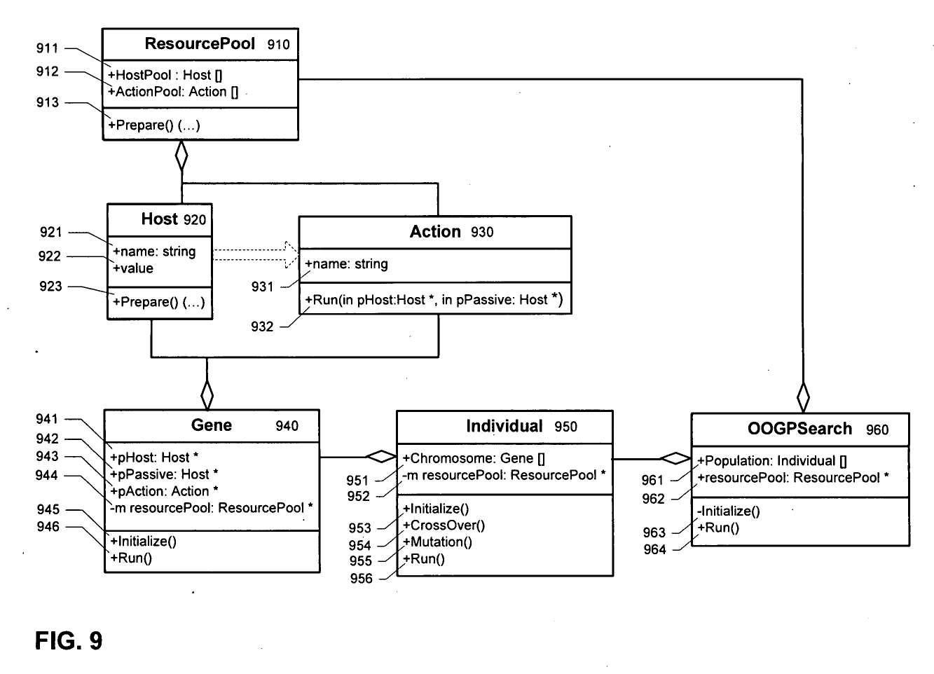

Mass storage 725 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc. According to one embodiment, mass storage 725 has tangibly embodied thereon instructions, which when executed by processor(s) 705, cause instances of one or more of the classes of FIG. 9 to be instantiated to identify a computer program solution to a problem at issue as described further below.

Bus 730 communicatively couples processor(s) 705 with the other memory, storage and communication blocks. Bus 730 can include a bus, such as a Peripheral Component Interconnect (PCI)/PCI Extended (PCI-X), Small Computer System Interface (SCSI), USB or the like, for connecting expansion cards, drives and other subsystems as well as other buses, such a front side bus (FSB), which connects the processor(s) 705 to system memory.

Optionally, operator and administrative interfaces, such as a display, keyboard, and a cursor control device, may also be coupled to bus 730 to support direct operator interaction with computer system 700. Other operator and administrative interfaces can be provided through network connections connected through communication ports 710.

Removable storage media 740 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Components described above are meant only to exemplify various possibilities. In no way should the aforementioned exemplary computer system limit the scope of the invention.

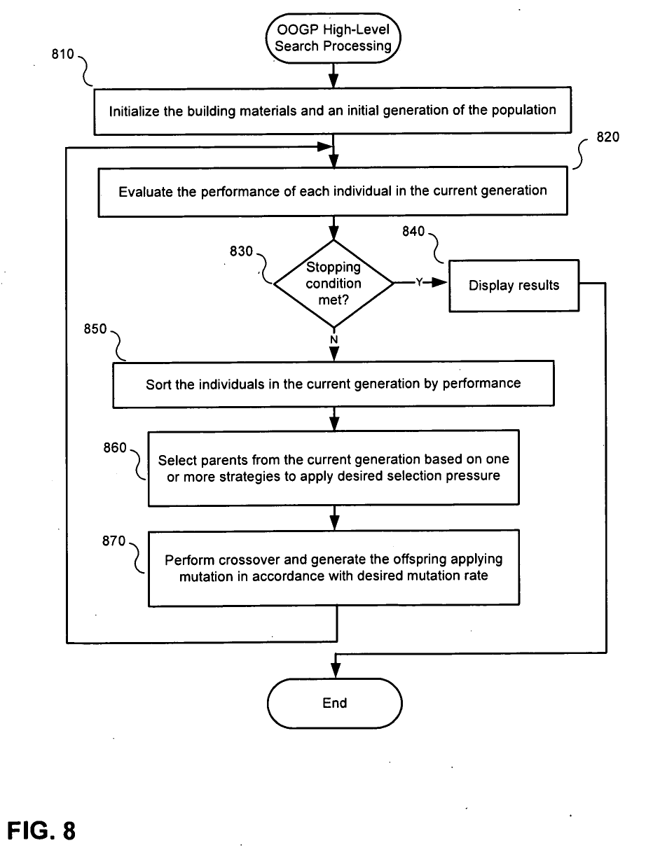

FIG. 8 is a high-level flow diagram illustrating object-oriented genetic programming (OOGP) search processing in accordance with an embodiment of the present invention.

At block 810, the building materials are initialized as well as an initial generation of the population. In one embodiment, the building materials are objects (e.g., type A objects 511 and type B objects 512), which may be stored in a resource pool. According to one embodiment, some or all of the building materials may represent objects associated with an existing object-oriented class library, package or application programming interface (API). Alternatively, some or all of the building materials may be randomly initialized by selecting random objects within the object domains. In one embodiment, at least one no-op operation is included within the resource pool.

For the case of problems with a single terminal, such as a function in the form y=f(x), there are N instances of type A class (ClassA_i). According to one embodiment, during the evaluation process, first the resource pool is prepared/initialized/setup. If there are M points of X (X_m), each ClassA_i may be initialized with X_m. For the case of multiple terminals, such as a function in the form y=f(x1, x2, . . . , x_k), where x is a vector with dimension K. Each of the instances of type A class may be initialized sequentially with one dimension of the given vector X_m. Both of these initialization examples are conceptual. Particular embodiments of OOGP need not necessarily follow either of these approaches. Based on the disclosure provided herein, one of ordinary skill in the art will recognize a variety of initialization approaches that may be used in relation to different embodiments of the present invention.

According to one embodiment, the initial generation may then be initialized using one of many initialization strategies, including, but not limited to a random strategy or a ramped half-and-half initialization. For example, for each gene of a chromosome for each individual, two random type A objects may be selected from the resource pool to serve as the host object 531 and passive object 533 and a random action may be selected from the resource pool to serve as the operation/action object 532. Based on the disclosure provided herein, one of ordinary skill in the art will recognize a variety of initial generation initialization approaches that may be used in relation to different embodiments of the present invention.

At block 820, the performance of each individual in the current generation is evaluated with a fitness function. According to one embodiment, the output of the fitness function may represent how close the individual is to a predetermined target (e.g., the desired result). For example, in the simple case of a “Hello world!” program, which is attempting to generate the string “Hello world!”, a fitness function may measure the difference (e.g., the sum of the absolute value differences between each corresponding character) between each individual (i.e., a twelve character string) of the current generation and the target string (i.e., “Hello world!”). Alternatively, the fitness function may represent how close the individual is to operating within one or more predefined constraints (e.g., finding a solution to the even parity problem in the form of a mathematic expression which outputs true if the number of the given N bits that are equal to one is even; otherwise the expression returns false.

At decision block 830, a determination is made regarding whether a predetermined stopping condition is met. Depending upon the problem domain and the particular implementation, there are many possible ways of expressing a stopping condition. According to one embodiment, the stopping condition may be expressed relative to or with respect to the fitness function. For example, in the case of the “Hello world!” program, the sum of the absolute value differences between each corresponding character in an individual of the population and the target string is zero. In other embodiments, the stopping condition may be with reference to a convergence rate over the course of multiple generations. The stopping condition may also be expressed in terms of the number of generations that have been produced. In any event, if the stopping condition is met, then processing branches to block 840; otherwise, processing continues with block 850.

At block 840, the stopping condition has been met; therefore, results of the search processing are output. Output of the results may include display of one or more of the final solution to the problem at issue, the number of interim objects, the chromosome length, the population size, the amount of processing time consumed, a measure of effort, success rate and the generation on success. At this point, search processing is complete.

At block 850, the stopping condition has not been met; therefore, search processing continues by sorting the individuals in the current generation by performance as measured in block 820.

At block 860, sets of parents for offspring generation are selected from the current generation. In nature, selection pressure generally refers to the intensity with which an environment tends to eliminate an organism (and thus its genes), or tends to give the organism an adaptive advantage. In the context of OOGP, the more selection pressure that is applied, the greater the chance there is for arriving at a premature solution as the most suitable individuals in the population will have the best chances for reproduction. For example, in a given search space, N, in which the population size is M and the selection pressure is high, if one of the individuals happens to have a much better performance than the others, then the search processing may simply converge to the individual having the best performance.

Various selection strategies may be applied to selection of parents to achieve desired selection pressure. In one embodiment, one parent of each pair may be selected from the best portion of the current generation (as defined by a predefined or configurable percentage, for example) and the other parent of each pair may be selected from the remainder of the current generation. Another selection strategy involves keeping the a predetermined or configurable percentage of the best performers in the current generation for the next generation and randomly choosing one parent from a second predetermined or configurable percentage of the best performers in the current generation and the other parent from the remainder. For example, the best 10% of the current generation may be rolled into the next generation unchanged and additional members of the next generation may be produced by pairs of parents selected from the current generation. One parent of each pair may be randomly selected from the best ⅓ of the current generation, for example, and the another parent may be randomly selected from the remaining ⅔ of the current generation.

The number of pairs of parents or the number of offspring each pair of parents will produce is a function of the maximum population size and how many, if any, individuals from the current generation will be part of the next generation. In some embodiments, one or more individuals may participate in two or more pairs of parents and one or more individuals may not participate in any pairs of parents. In some embodiments, there may be a maximum or minimum number (randomly selected, predetermined or configurable) of offspring generated by each pair of parents. Alternatively, each pair may produce the same number of offspring (e.g., one offspring per pair). While in nature, the genetic material of two and only two parents is combined to produce offspring and the discussion above has focused on pairs of parents, there is no such limitation in genetic programming and a set of parents that produces offspring can involve more than two parents with configurable, predetermined or random percentage contributions of genetic material from each parent. Meanwhile, various other parent selection strategies include, but are not limited to rank selection and tournament selection. Based on the disclosure provided herein, one of ordinary skill in the art will recognize a variety of parent selection approaches that may be used in relation to different embodiments of the present invention. Alternative parent selection approaches may be described in one or more of “A Field Guide to Genetic Programming,” by Riccardo Poli et al. (ISBN-13: 9781409200734), “Genetic Programming: On the Programming of Computers by Means of Natural Selection,” by John Koza (ISBN-13: 9780262111706), “Genetic Programming IV: Routine Human-Competitive Machine Intelligence,” by John Koza et al. (ISBN-13: 9781402074462), “An Introduction to Genetic Algorithms,” by Melanie Mitchell (ISBN-13: 9780262631853), “Introduction to Evolutionary Computing,” by A. E. Eiben et al. (ISBN-13: 97835404018410) and “Genetic Algorithms in Search, Optimization, and Machine Learning,” by David E. Goldberg (ISBN-13: 9780201157673) all of which are hereby incorporated by reference in their entirety for all purposes.

According to one embodiment, a rank selection approach to selecting parents may involve the following:
Sorting the population by their fitness values.
Assigning each individual a rank. For example, rank=1 for the best individual, rank=2 for the second best individual and so on.
Then, the probability of being selected is p*r, where p is some fixed probability and r is the rank of the individual. A proper probability value, p, varies for different problems.

According to one embodiment, a tournament selection approach to selecting parents may involve the following:
Pick n individuals from the population.
With fixed probability, p, choose the one with the highest fitness, otherwise choose one of the others at random. Proper p and n values vary for different problems.

At block 870, crossover is performed among the pairs of parents selected in block 860 to generate offspring while also applying mutation at a predetermined or configurable rate. As will be described further below, crossover involves the selection of genetic material that will be inherited by the offspring from each of the parents. There are various ways of implementing a crossover operation. In one embodiment, one of the parents can be used as a template for the offspring and then random portions of the chromosome can be selected and replaced with random or corresponding portions of the other parent until the desired crossover percentage is achieved.

While the contribution of genetic mutations in human and animal species to improvement or benefit of the species is the subject of ongoing debate, embodiments of the present invention allow for a configurable, predetermined or random mutation rate in each generation. In one embodiment, the mutation process is intended to roughly correspond to genetic mutations in nature at the rate of between approximately 0.01 and 0.1% of the population. In one embodiment the mutation rate in the population is approximately 0.05%. In one embodiment, mutation involves the random replacement of one or more genes in an individual selected for application of mutation. To the extent mutation is not desired for a particular implementation or problem domain, the mutation rate can be set to zero percent. In one embodiment, mutation is applied in accordance with the mutation rate to offspring. In other embodiments, the whole generation (e.g., even those individuals rolled over from the previous generation may be candidates for being mutated).

FIG. 9 is a Unified Modeling Language (UML) class diagram illustrating various classes in accordance with various embodiments of the present invention. In the current example, the classes include ResourcePool 910, Host 920, Action 930, Gene 940, Individual 950 and OOGPSearch 960.

In accordance with the present example, ResourcePool 910 includes an array of Hosts 920, e.g., HostPool 911 and an array of Actions 930, e.g., ActionPool 912. ResourcePool 910 also includes a prepare method, e.g., Prepare 913, which is operative to initialize the building materials.

Host 920 includes a name 921 and a state, e.g., value 922. Host 920 also includes a prepare method, e.g., Prepare 923, which allows name 921 and value 922 to be initialized.

Action 930 includes a name attribute, e.g., name 921, and a run operation, e.g., Run( ) 932, which takes as parameters pointers to two instances of Host 920. In one embodiment, Run( ) 932 causes the value of the object (Host) referenced by the first parameter to perform a defined action on the value of the object (Passive) referenced by the second parameter (Passive). For example, invoking the Run( ) operation 932 of an instance of an Action 930 representing a division mathematical operation with a pointer to a first host object (Host) having a value of 2 and a pointer to a second host object (Passive) having a value of 10 produces a result of 5 (i.e., 10 divided by 2). This, of course, is simply a convention and in other embodiments, the so called “active” host and the so called “passive” host may be reversed.

Gene 940 includes three public attributes (i.e., pHost 941, a pointer to a Host 920, pPassive 942, a pointer to a Host 920, and pAction 944, a pointer to an Action 930) and one private attribute (i.e., resourcePool, a pointer to ResourcePool 910). Gene 940 also includes an initialization operation (i.e., Initialize( ) 945) and a run operation (i.e., Run( ) 946). The initialize operation may be used to assign initial values to the attributes of the Gene. The run operation may be used to evaluate the Gene (e.g., apply the action referenced by pAction 944 to pHost 941 and pPassive 942).

Individual 950 includes a public attribute (i.e., Chromosome 951, an array of Genes 940) and a private attribute (i.e., resourcePool, a pointer to ResourcePool 910). Individual 950 also includes various operations, including an Initialize( ) operation 953, a CrossOver( ) operation 954, a Mutation( ) operation 955 and a Run( ) operation 956, for initializing, manipulating and evaluating the Chromosome 951.

OOGPSearch 960 includes an array of Individuals 950, Population 961, and a reference to an instance of a ResourcePool 910. OOGPSearch 960 also includes a private initialization operation (i.e., Initialize( ) 963) and a public evaluation operation (i.e., Run( ) 964).

Depending upon the particular implementation, the various process and decision blocks described below may be performed by hardware components, embodied in machine-executable instructions, which may be used to cause a general-purpose or special-purpose processor programmed with the instructions to perform the steps, or the steps may be performed by a combination of hardware, software, firmware and/or involvement of human participation/interaction.

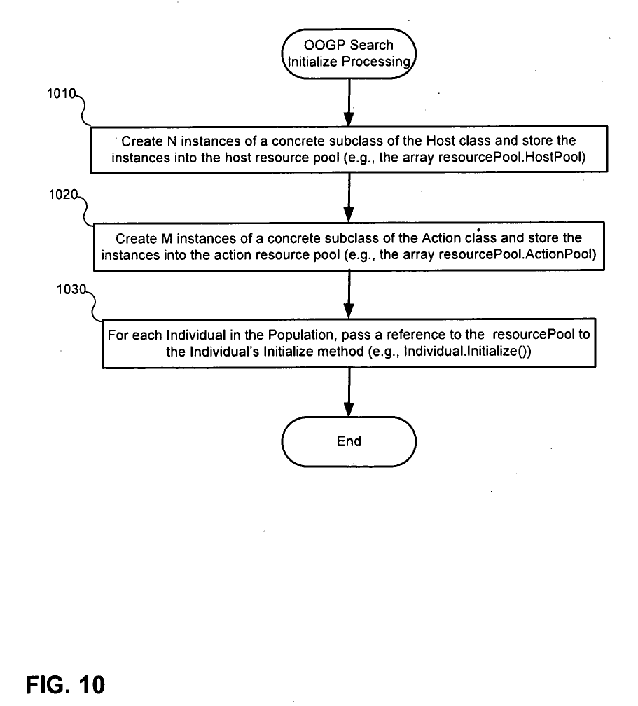

FIG. 10 is a flow diagram illustrating initialize processing for the OOGPSearch class of FIG. 9 in accordance with an embodiment of the present invention. In the current example, there are two general functions of the OOGPSearch initialize operation, initialization of a resource pool, such as an instance of ResourcePool 910 and initialization of the population.

At block 1010, responsive to invocation of the initialize operation of the OOGPSearch class 960, N instances of the Host class (e.g., Host class 920) or a concrete subclass thereof are created and stored, for example, within a host pool of the resource pool.

At block 1020, M instances of the Action class (e.g., Action class 930) or a concrete subclass thereof are created and stored, for example, within an action pool of the resource pool.

At block 1030, the Population is initialized by invoking the initialize operation for each individual in the population. Further details regarding initialization processing will be described below.

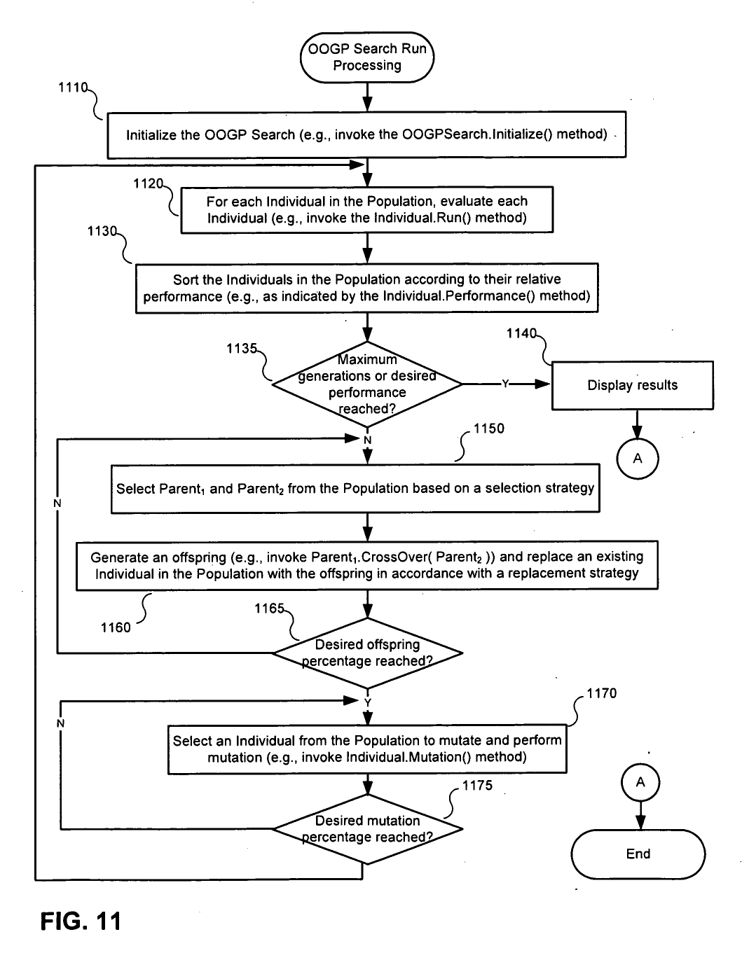

FIG. 11 is a flow diagram illustrating run processing for the OOGPSearch class of FIG. 9 in accordance with an embodiment of the present invention. At block 1110, the search is initialized, for example, by invoking the initialize operation of an instance of the OOGPSearch class 960. While in one embodiment, the initialize operation of the OOGPSearch class 960 is a private operation and invoked internal to the run operation of the OOGPSearch class 960, in other embodiments, the initialize operation may be public and simply invoked prior to invocation of the run operation. In any event, after initialization of the resource pool and the population have been completed, an iterative process of evaluating the current generation and creating subsequent generations can commence.

At block 1120, an initial evaluation is performed by invoking the run operation of each individual in the first generation of the population. Exemplary run processing is described further below.

At block 1130, the individuals of the population are sorted according to their relative performance, which may be determined by invoking a performance operation of the individuals. Exemplary performance evaluation processing for individuals is described further below.

At decision block 1135, a determination is made regarding whether search processing is complete. Exemplary stopping conditions for the search processing include a maximum number of generations having been achieved or a desired performance having been reached. If conditions indicative of search processing being complete are met, the processing branches to block 1140; otherwise search processing continues with block 1150.

At block 1140, the search results may be displayed or otherwise preserved. In one embodiment, display of the search results may include display of (i) search configuration information, including, but not limited to, the population size, the chromosome length, the initialization approach/methodology, the selection strategy for producing the next generation, the crossover configuration, the mutation rate and/or implementation and the success criteria or stopping condition triggered; (ii) statistical result information, including, but not limited to, the generation at which the search processing stopped and a value of the performance/fitness function and/or (iii) the solution to the problem at issue. Also, intermediate statistics and/or information may be periodically displayed or stored to a log file, for example, noting the current generation and values, such as a range of performance values for the individuals of the current generation.

At block 1150, parents (e.g., parent₁ and parent₂) are selected from the current generation in accordance with a predefined or configurable selection strategy to produce the next generation. Many selection strategies are contemplated. For example, in accordance with one exemplary selection strategy, (i) the top X % (e.g., 10%) of the current generation may be kept unchanged for participation in the next generation and (ii) for the remaining (100−X)% (e.g., 90%) of the next generation, during each parent selection iteration, one parent (parent₁) may be randomly selected from the top fraction (e.g., ⅓) of the current generation and another parent (parent₂) may be randomly selected from the bottom (1-fraction) (e.g., ⅔) of the current generation. As indicated above, various selection strategies are contemplated. Notably, in various embodiments, the selection strategy may be the same or different for each subsequent generation. For example, a rank selection strategy may be used in one generation and a tournament selection strategy may be used in another generation.

At block 1160, having formed a desired pair of parents in accordance with a selection strategy, one offspring is generated for the selected pair of parents and the offspring replaces an existing individual in the population in accordance with a replacement strategy. According to one embodiment, the offspring is generated by invoking a crossover operation of one parent with the other as a parameter (e.g., Parent₁.CrossOver(Parent₂)). In one embodiment, more than one offspring may be produced by a given pair of parents. The multiple offspring may represent fraternal or identical twins, for example. In some embodiments, the number of offspring for a given pair of parents may be randomly determined or a weighing strategy may be applied to give parents having more desirable qualities to have more of a chance of having multiple offspring.

In one embodiment, each pair of parents generate two offspring. Selection pressure is used to make sure better individuals have a better chance to pass their genes to the next generation (e.g., they are selected more often as parents than those with lesser performance). In other embodiments, each pair of parents generate a single offspring. In some embodiments, the number of offspring generated by a pair of parents may vary on a case-by-case or generation-to-generation basis.

Various replacement strategies are contemplated. In one embodiment, parent₂ is carried over into the next generation and the offspring of parent₁ and parent₂ replaces parent₁ in the next generation.

In one embodiment, the best 10% of individuals of the current generation are kept unchanged and passed to the next generation. The remaining 90% of the population for the next generation is generated in the form of offspring to replace the discarded portion of the current generation.

In some embodiments, the next generation is 100% represented as new offspring of the current generation. Various other replacement strategies are contemplated and discussed in the literature (e.g., “A Field Guide to Genetic Programming,” by Riccardo Poli et al., “Genetic Programming: On the Programming of Computers by Means of Natural Selection,” by John Koza, “Genetic Programming IV: Routine Human-Competitive Machine Intelligence,” by John Koza et al., “An Introduction to Genetic Algorithms,” by Melanie Mitchell, “Introduction to Evolutionary Computing,” by A. E. Eiben et al. and “Genetic Algorithms in Search, Optimization, and Machine Learning,” by David E. Goldberg which were previously incorporated by reference).

At decision block 1165, a determination is made regarding whether the desired offspring threshold has been reached. The desired offspring threshold may be measured as a percentage of the population represented by offspring, a percentage of parents participating in offspring producing pairs, as a fixed or configurable number of offspring. In one embodiment, a parent may participate in only one offspring producing pair of parents. In other embodiments, a given individual may participate in more than one offspring producing pairs, for example, if its performance is ranked higher than moth of the other individuals. At any rate, until the desired offspring threshold has been reached, processing continues by branching back to block 1150 where another pair of parents is selected for further offspring generation. Once the desired offspring threshold has been reached, processing continues with block 1170.

At block 1170, an individual from the population is randomly selected for mutation. In one embodiment, an individual is mutated by invoking its mutation operation. Further details regarding the implementation of the mutation operation are described below.

At decision block 1175, a determination is made regarding whether the desired mutation threshold has been reached. The desired mutation threshold may be measured as a percentage of mutants in the population or as a fixed or configurable number of mutants. Until the desired mutation threshold has been reached, processing continues by branching back to block 1170 where another individual is selected for mutation. According to the present example, once the desired mutation threshold has been reached, the current generation is deemed complete and processing continues with block 1120 where the current generation is evaluated.

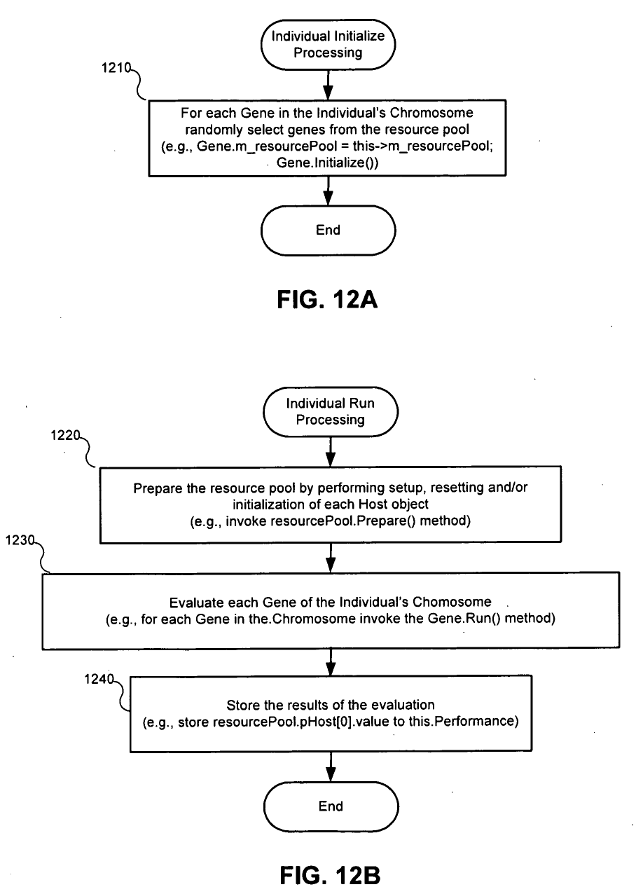

FIG. 12A is a flow diagram illustrating initialize processing for the Individual class of FIG. 9 in accordance with an embodiment of the present invention. According to the current example, the initialize operation of an individual has a single step (i.e., block 1210) in which, for each gene in the individual's chromosome, a gene is randomly selected from the resource pool and a reference to the randomly selected gene is stored.

FIG. 12B is a flow diagram illustrating run processing for the Individual class of FIG. 9 in accordance with an embodiment of the present invention.

At block 1220, the resource pool is prepared by performing appropriate setup, resetting and/or initialization of each host object. For example, instantiation of type A and type B classes. In one embodiment, this preparation of the resource pool is performed by invoking a prepare operation of the resource pool.

At block 1230, each gene of the individual's chromosome is evaluated by invoking the run operation of each gene, for example.

At block 1240, the results of the evaluation are stored.

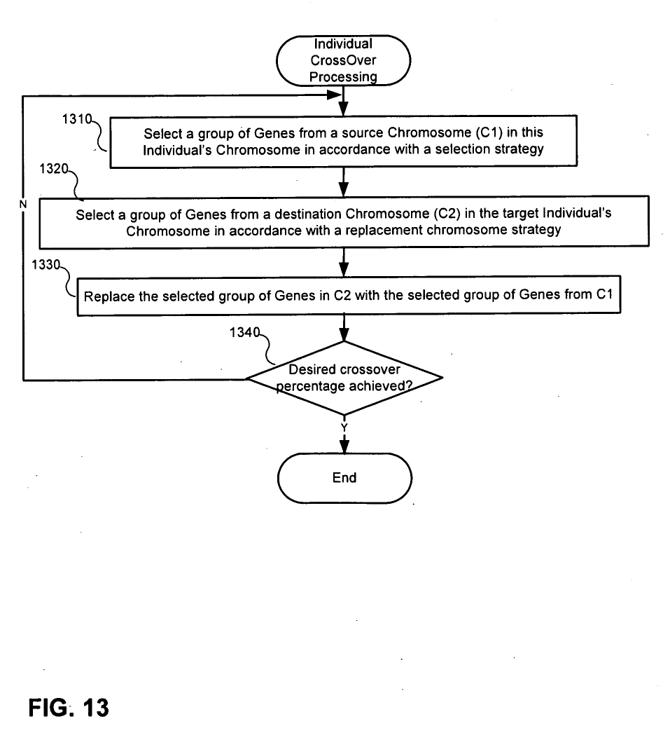

FIG. 13 is a flow diagram illustrating crossover processing for the Individual class of FIG. 9 in accordance with an embodiment of the present invention.

At block 1310, a group of one or more genes from a source chromosome in the individual's chromosome are selected in accordance with a selection strategy. Various selection strategies are contemplated. For example, a linear sequence of one or more genes representing a particular percentage or a fixed number of genes of C1 may be selected. Alternatively, genes may be randomly selected from C1 and such selected genes need not be contiguous. Based on the disclosure provided herein, one of ordinary skill in the art will recognize a variety of different selection strategies that might be used in relation to different embodiments of the present invention.

At block 1320, a group one or more genes from a destination chromosome are selected in accordance with the same of different selection strategy as that employed in block 1310. Various selection strategies are again contemplated. For example, as above, a linear sequence of one or more genes representing a particular percentage or a fixed number of genes of C2 may be may be selected. Alternatively, a contiguous or discontiguous set of one or more genes may be randomly selected from C2. The group of genes selected in C2 may be determined based upon corresponding genes selected in C1 (e.g., if positions 1, 3 and 8 of the Chromosome array of C1 are selected then corresponding locations of C2 may be selected) or there may be no set relationship between the two sets of selected genes (e.g., positions 1, 3 and 8 of the Chromosome array of C1 may end up corresponding to positions 5, 7 and 2 of the Chromosome array of C2). Based on the disclosure provided herein, one of ordinary skill in the art will recognize a variety of different selection strategies that might be used in relation to different embodiments of the present invention.

At block 1330, the selected group of genes in C2 are replaced with the selected group of genes from C1.

At decision block 1340, a determination is made regarding whether a desired crossover percentage has been achieved. In some embodiments, crossover is intended to mimic nature in which 50% of genes are from one parent and 50% are from the other. In other embodiments, however, the percentage may be configurable, vary or be predefined as another percentage. If the desired crossover percentage has not been achieved based on those genes in C2 that have been replaced with those from C1, then crossover processing continues by looping back to block 1310; otherwise the target individual now represents an offspring having the desired crossover percentage and crossover processing is complete.

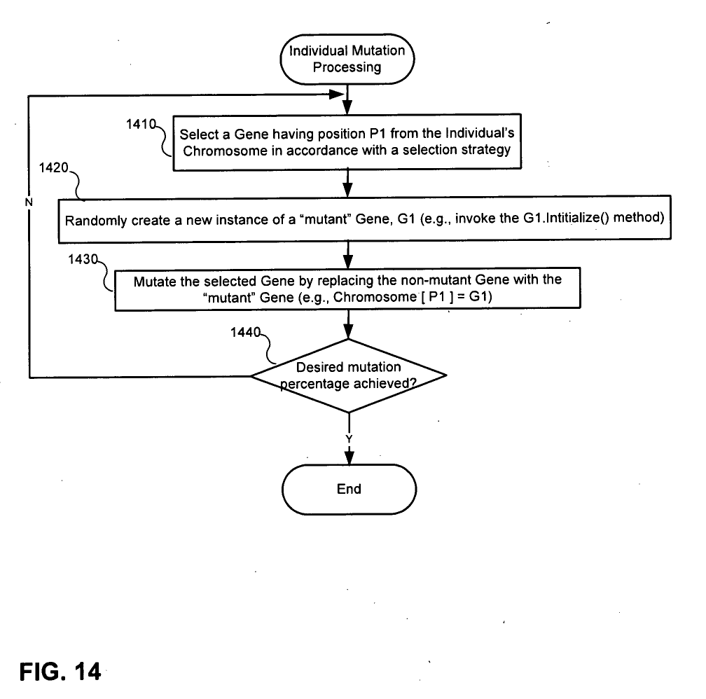

FIG. 14 is a flow diagram illustrating mutation processing for the Individual class of FIG. 9 in accordance with an embodiment of the present invention.

At block 1410, a gene within the individual's chromosome is selected in accordance with a selection strategy (e.g., random or otherwise) to be the target of a mutation. In some embodiments, certain positions within the chromosome may be more or less likely to become mutated.

Various factors affect mutation processing, including, but not limited to the chance of mutation (i.e., mutation rate), the percentage of genes in a mutated individual that are mutated and whether mutated genes are continuous or discrete. Dependent upon the particular implementation, there variables may be selected in accordance with existing or future literature or observations in nature. Based on the disclosure provided herein, one of ordinary skill in the art will recognize a variety of different selection strategies might be used in relation to identifying an appropriate mutation target in the context of different embodiments of the present invention.

At block 1420, a new instance of a gene, which will serve as the mutant gene, is randomly created.

At block 1430, a point mutation is simulated by replacing the gene selected in block 1410 with the mutant gene, which was randomly created in block 1420. In some embodiments, mutation may also mimic other mutations, including, but not limited to, insertions or deletions. For example, an insertion may result in all genes being shifted to the right in the Chromosome array (with the last gene being dropped) and a deletion may result in all genes being shifted to the left in the Chromosome array (with the last gene being initialized as a no-op, for example). More complex mutations, such as chromosomal duplication, chromosomal breakage and realignment, retroviruses, plasmids, bacterial DNA exchange, higher level transfer, symbiotic transfer and/or transpositions, may also be accommodated depending upon the needs and/or desires of the particular implementation.

At decision block 1440, a determination is made regarding whether the desired mutation threshold has been achieved. In some embodiments, from approximately one to ten genes are mutated. In one embodiment, approximately 1% to 3% of the genes are mutated. In one embodiment, two genes are mutated. If the desired mutation threshold has not been achieved based on those already mutated, then mutation processing continues by looping back to block 1410; otherwise mutation processing is complete.

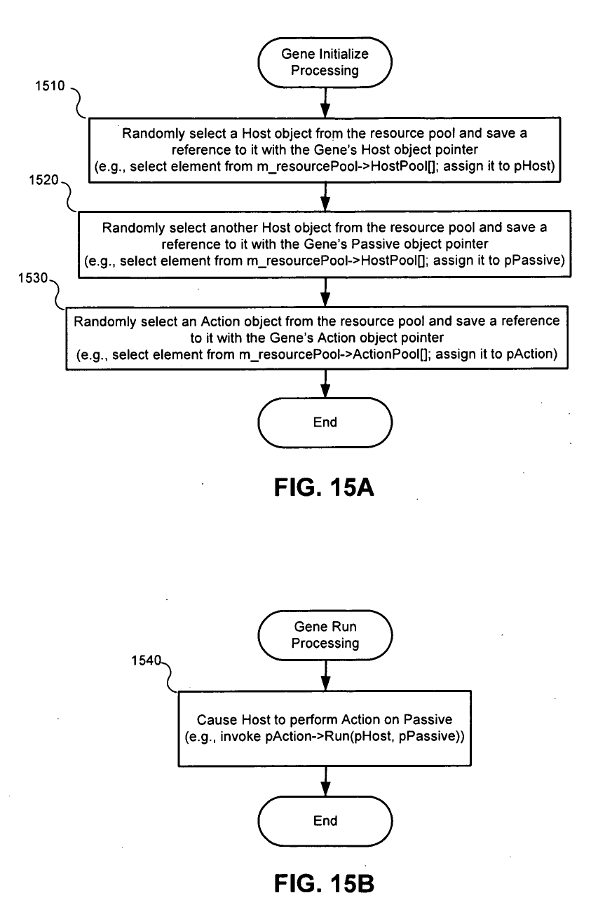

FIG. 15A is a flow diagram illustrating initialize processing for the Gene class of FIG. 9 in accordance with an embodiment of the present invention.

At block 1510, an instance of a host object is randomly selected from the resource pool and a reference to the host object is stored within the gene (e.g., a host object pointer within the gene is assigned the address of the randomly selected host object).

At block 1520, an instance of another host object is randomly selected from the resource pool and a reference to the second host object is stored within the gene (e.g., a second host object pointer within the gene is assigned the address of the randomly selected host object).

At block 1530, an instance of an action object is randomly selected from the resource pool and a reference to the action object is stored within the gene (e.g., an action object pointer within the gene is assigned the address of the randomly selected host object).

FIG. 15B is a flow diagram illustrating run processing for the Gene class of FIG. 9 in accordance with an embodiment of the present invention. According to the current example, the run operation can be represented in a single step (e.g., block 1540) in which the host object is caused to perform the action on the passive object.

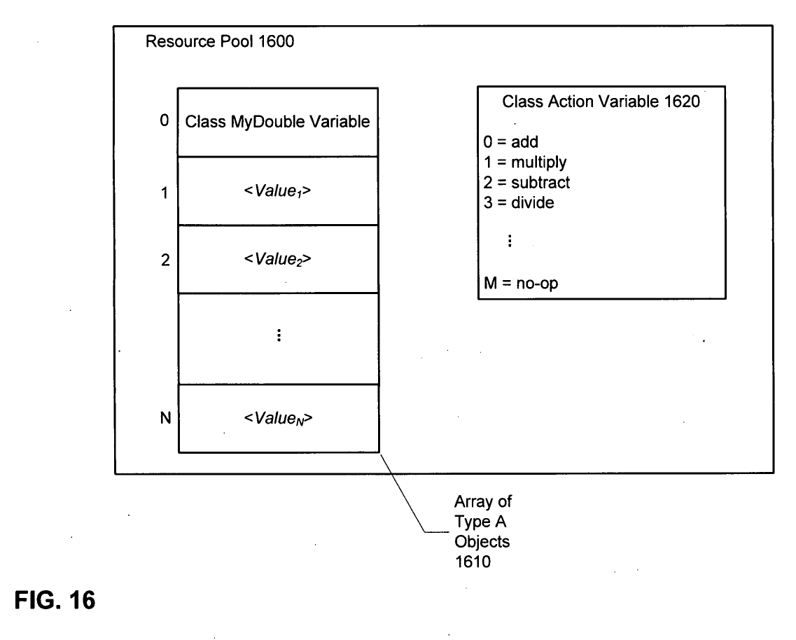

FIG. 16 is a block diagram conceptually illustrating a resource pool in accordance with an embodiment of the present invention. In the present example, resource pool 1600 includes an array of type A objects 1610 and a class action variable 1620. Each of the N type A objects at indices 1 to N of the Array of type A objects 1610 holds a value of type MyDouble Variable. Depending upon the value 0 to M, the class action variable 1620 may represent M+1 operations, e.g., add, multiply, subtract, divide, no-op, etc.

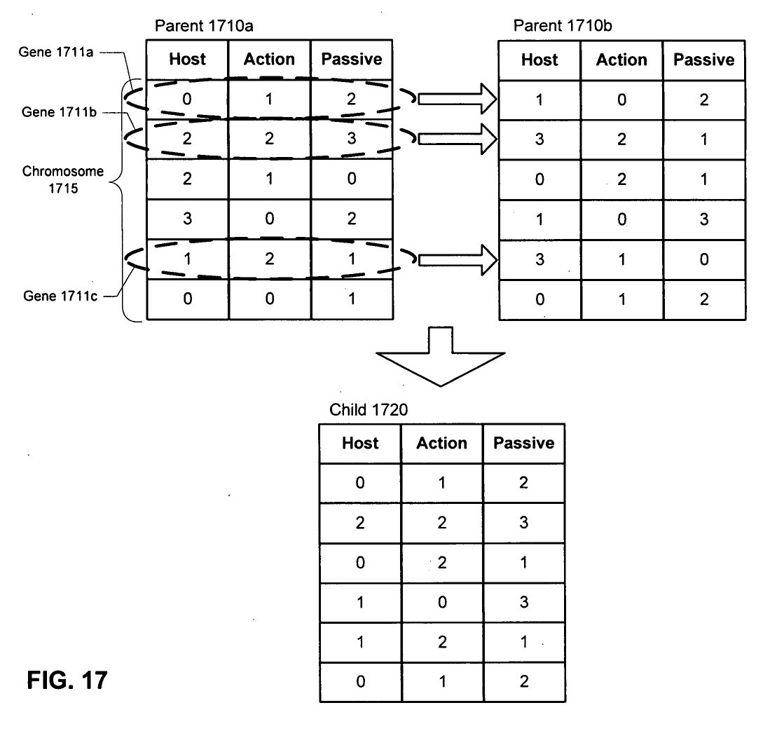

FIG. 17 illustrates a crossover operation in the context of various embodiments of the present invention. For purposes of illustration, generation of an offspring by way of a crossover operation is illustrated between a simplified conceptual representation of individuals. In the current example, a crossover operation of a first parent 1710a is invoked with a second parent 1710b resulting in another simplified representation of an individual (i.e., child 1720). In the current example, parent 1710a includes chromosome 1715 comprising multiple genes, including genes 1711a-c. Genes 1711a-c, representing 50% of the genes of parent 1710a, are selected for replacement of corresponding genes in parent 1710b to create child 1720. Thus, child 1720 represents the combination (or crossover) of parent 1710a and parent 1710b in which parent 1710b may be said to be the template that is modified by the selected genes (e.g., genes 1711a-c) of parent 1710a. As indicated above, this is a simplified example presented solely for the purpose of illustrating one possible implementation of a crossover operation in the context of a simplified representation of individuals (e.g., having only 6 genes).

Tying this illustration to the resource pool of FIG. 16, gene 1711a can be interpreted as having a host object of type MyDouble having a value of 0, a passive object of type MyDouble having a value of 2 and an action representing multiplication. Again, this is to be understood as a simplified example constructed to illustrate an exemplary implementation of a crossover operation. As described further below, the true structure or memory based representation of an individual may be different than that illustrated in FIG. 17. For example, rather than containing values of objects within the individual, references (e.g., pointers) to objects may be used. Furthermore, among other things, the host object, the passive object and the action object may have more complex representations and the number of genes may be larger.

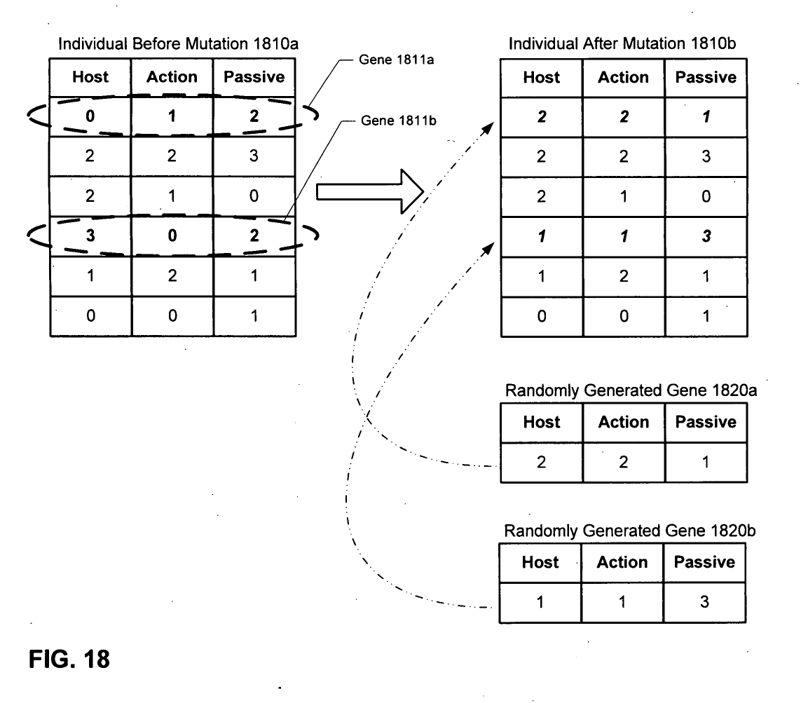

FIG. 18 illustrates a mutation operation in the context of various embodiments of the present invention. For purposes of illustration, generation of a mutant by way of a mutation operation is illustrated with reference to a simplified conceptual representation of an individual before mutation 1810a and the same individual after mutation 1810b. In the current example, the mutation operation of the individual 1810a is invoked resulting in a mutated individual 1810b. In the current example, individual 1810a includes multiple genes, including genes 1811a-b. Genes 1811a-b, representing a desired threshold of mutation, are selected for replacement by randomly generated genes 1820a and 1820b to create mutant individual 1810b. Thus, mutant individual 1810b represents the mutation of individual 1810a at genes 1811a and 1811b with genes 1820a and 1820b. As indicated above, this is a simplified example presented solely for the purpose of illustrating one possible implementation of a mutation operation in the context of a simplified representation of individuals (e.g., having only 6 genes and containing values of objects rather than references to objects). As described further below, the true structure or memory based representation of an individual may be different than that illustrated in FIG. 18.

The basic OOGP algorithms described above utilize the encapsulation feature of object-oriented programming. However, most modern object-oriented languages do not support the definition of dynamic classes, therefore in order to utilize other features of object-oriented programming, it is desirable to operate on a higher level representation of the program than the executable, such as the source code level or meta-object models, for example.

While in the following examples, the computer program representation will be based on source code, it is to be noted that other computer program representations are contemplated, including, but not limited to, graph representations, modeling languages/representations, such as UML, Code Document Object Model (CodeDOM), source code in the form of a high or low-level programming language (e.g., C, C++, C# Java, etc.) and computer programs in executable form. Most of the features used by object oriented programming can be materialized with source code. Meanwhile, there are other types of methods that are used in objected oriented programming, such as using graph, meta-object model, etc. These approaches can be considered in a higher level than using source code. After compilation, the executable binary of object oriented programs is no different from that of procedural programming, at least in terms of readability to humans.

In order to fully utilize the semantics on the level of source code in object oriented programming, such as inheritance, composition and overriding, etc, ideally the algorithm should be able to support most of these semantics. Also, the algorithm should have the necessary crossover/mutation operations that support these semantics.

While it is difficult to operate directly on source files since they are purely text strings, fortunately, there are many frameworks and tools that facilitate the generation of source code. In the examples, below the Code Document Object Model (Code DOM) of may be used as an example.

Code Document Object Model (CodeDOM) is a mechanism within the dotNET framework that enables source code to be dynamically generated in multiple programming languages such as C# and C++, at run time, based on a single model that represents the code to render. Under the CodeDOM model, each line of source code is called a statement, and it is broken down into several objects with different semantics, such as variables and assignments.

For example, if the source code is

```
        myDouble_3.Minus(myDouble_5);,
    the CodeDOM representation is
        CodeMethodInvokeExpression  Invoke  = new
            CodeMethodInvokeExpression(new
            CodeVariableReferenceExpression(“myDouble_3”),
            “Minus”,  new  CodeExpression[ ] { new
            CodeVariableReferenceExpression(“myDouble_5”) });
        Statements.Add(Invoke);,
    Where CodeMehodInvokeExpression,
CodeVariableReferenceExpression, CodeExpression are all predefined
classes in CodeDOM.
```

Just like classic genetic algorithms, the basic OOGP algorithms described above and the OOGP algorithms described below have the following steps:
Step #1: Initialize the first generation
Step #2: Evaluate the population; stop if the condition is met
Step #3: Generate the offspring
Step #4: Go to step 2

In the following examples, since a different representation for the gene is used, each of the above steps has significant differences from that described above.

In the following examples, each gene (here called an “Instruction”) is used to generate a statement of source code. The gene contains necessary data used as input to CodeDOM statement classes.

For example, if the source code is

```
        myDouble_3.Minus(myDouble_5);,
    the CodeDOM code is
        CodeMethodInvokeExpression Invoke = new
            CodeMethodInvokeExpression(new
            CodeVariableReferenceExpression(myInstr.VariableName)
            ,  myInstr.MethodName,  new  CodeExpression[ ] { new
            CodeVariableReferenceExpression(myInstr.Parameters)
            });
        Statements.Add(Invoke);,
The  object  myInstr  is  assigned  in  the  genotype  as
(VariableName=myDouble_5, MethodName=Minus,
Parameters=myDouble_5).
```

According to one embodiment, this additional layer makes the manipulation of the object oriented program's source code much easier. For example, the method's names can be swapped in two statements, meanwhile using reflection to check if the parameters are valid.

Under a managed code environment, reflection can be used to explore the existing class library. There is no need to manually build the prototype database of classes and class methods. All this information can be obtained via reflection and can be put into a database. Later the database can be used to initialize the population. For example, for the variable definition statement, randomly pick the class name from the established database as the type. For the method invocation statement, query the database and randomly pick one of the method names belonging to its class type.

Since the existing libraries from the developing environment may contain too many classes, a pre-defined scope may be used to reduce the search space. For example, one may simply restrict the classes to those within a specific user generated code module.

For the above example of an instruction, the crossover operation can be implemented, for example, by simply switching either two whole Instructions or part thereof. For the mutation operation, one potential implementation is to simply re-initialize the Instruction.

For example, if the instruction class is:

Class Instr {
String variableName, methodName, parameterName;
};,

Crossover can be performed by simply replacing selected Instruction tuples in one parent with corresponding Instruction tuples in the other, for example.

Meanwhile, to evaluate each individual, first the source code from each gene of the chromosome may be generated and compiled. The compiled code may then be put in the application domain under a managed code environment, the generated class can then be instantiated, and finally its methods can be invoked to evaluate the return value of a given method.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A method of identifying a computer program solution to a problem at issue in a particular domain, the method comprising:
one or more software modules varying a population of a plurality of computer program representations tangibly embodied within a computer-readable medium to create a new population by generating additional computer program representations based on one or more of the plurality of computer program representations selected in accordance with a selection strategy, each of the plurality of computer program representations modeled as a linear array of genes, each gene of which has associated therewith one or more domain-specific values and an action or operation to be performed on the basis of the one or more domain-specific values;
the one or more software modules determining whether any computer program representations of the new population satisfy one or more predetermined performance criteria;
if the one or more predetermined performance criteria are satisfied by one or more of the computer program representations of the new population, then the one or more software modules identifying the one or more of the computer program representations as potential solutions to the problem at issue;
if none of the computer program representations of the new population satisfy the predetermined performance criteria, then the one or more software modules continuing to generate one or more subsequent generations until the one or more predetermined performance criteria are satisfied; and
wherein the one or more software modules are implemented in one or more processors and one or more computer-readable media of one or more computer systems, the one or more computer-readable media having instructions tangibly embodied therein that are executable by the one or more processors.

2. The method of claim 1, wherein the selection strategy comprises selecting for inclusion within the new population a predetermined or configurable percentage of the population that performs better than a remaining portion of the population as measured by a fitness function.

3. The method of claim 1, wherein the selection strategy comprises randomly choosing a first parent from a first portion of the population and randomly choosing a second parent from a second portion of the population.

4. The method of claim 3, wherein the first portion of the population exhibits performance as measured by a fitness function that is deemed more desirable than performance exhibited by the second portion of the population.

5. The method of claim 3, wherein said generating additional computer program representations comprises generating an offspring to be included within the new population by performing a crossover operation based on the first parent and the second parent.

6. The method of claim 5, further comprising mutating the offspring by randomly replacing at least a portion of the linear array of genes.

7. The method of claim 1, wherein each gene comprises a portion of source code of the corresponding computer program representation.

8. The method of claim 1, wherein each gene comprises data for input to Code Document Object Model statement classes.

9. The method of claim 1, wherein the one or more predetermined performance criteria comprise a measure of proximity between a result generated by a computer program representations of the new population and a predetermined result.

10. The method of claim 1, wherein the action or operation comprises a no-op operation.

11. A computer-readable storage medium tangibly embodying a set of instructions, which when executed by one or more processors of one or more computer systems, cause the one or more processors to:
vary a population of a plurality of computer program representations tangibly embodied within a computer-readable medium to create a new population by generating additional computer program representations based on one or more of the plurality of computer program representations selected in accordance with a selection strategy, each of the plurality of computer program representations modeled as a linear array of genes, each gene of which has associated therewith one or more domain-specific values and an action or operation to be performed on the basis of the one or more domain-specific values;
determine whether any computer program representations of the new population satisfy one or more predetermined performance criteria;
identify the one or more of the computer program representations as potential solutions to the problem at issue if the one or more predetermined performance criteria are satisfied by one or more of the computer program representations of the new population;
continue to generate one or more subsequent generations until the one or more predetermined performance criteria are satisfied if none of the computer program representations of the new population satisfy the predetermined performance criteria.

12. The computer-readable storage medium of claim 11, wherein the selection strategy comprises selecting for inclusion within the new population a predetermined or configurable percentage of the population that performs better than a remaining portion of the population as measured by a fitness function.

13. The computer-readable storage medium of claim 11, wherein the selection strategy comprises randomly choosing a first parent from a first portion of the population and randomly choosing a second parent from a second portion of the population.

14. The computer-readable storage medium of claim 13, wherein the first portion of the population exhibits performance as measured by a fitness function that is deemed more desirable than performance exhibited by the second portion of the population.

15. The computer-readable storage medium of claim 13, wherein said generating additional computer program representations comprises generating an offspring to be included within the new population by performing a crossover operation based on the first parent and the second parent.

16. The computer-readable storage medium of claim 15, wherein the set of instructions further cause the one or more processors to mutate the offspring by randomly replacing at least a portion of the linear array of genes.

17. The computer-readable storage medium of claim 11, wherein each gene comprises a portion of source code of the corresponding computer program representation.

18. The computer-readable storage medium of claim 11, wherein each gene comprises data for input to Code Document Object Model statement classes.

19. The computer-readable storage medium of claim 11, wherein the one or more predetermined performance criteria comprise a measure of proximity between a result generated by a computer program representations of the new population and a predetermined result.

20. The computer-readable storage medium of claim 11, wherein the action or operation comprises a no-op operation.
